(19) United States
(12) Patent Application Publication
(10) Pub. No.: US 2012/0146402 A1
(43) Pub. Date: Jun. 14, 2012

(54) CONTROL SYSTEM FOR REGULATING BUS VOLTAGE FOR AN ELECTRIC SHOVEL

(75) Inventors: Weixuan Liu, Alpharetta, GA (US); Claudio Bahomondes, Iquique (CL)

(73) Assignee: SIEMENS INDUSTRY, INC., Alpharetta, GA (US)

(21) Appl. No.: 12/963,711

(22) Filed: Dec. 9, 2010

(51) Int. Cl. B60L 1/00

(52) U.S. Cl. 307/9.1

(57) ABSTRACT

A control system for regulating a bus voltage used to power an electric shovel. The system includes a controller for controlling motions of the shovel and for providing a measurement of bus voltage of a bus. The system also includes a shunt resistor located in a current path of the bus and a current transducer for providing a current measurement based on current flowing through the shunt resistor. A converter is then used to regulate the bus voltage of the bus in response to the current and voltage measurements. The system may be retrofitted into older generation shovel drive and control systems.

### FIELD OF THE INVENTION

This invention relates to electric mining excavators, and more particularly, to a control system for maintaining bus voltage which is used to operate an electric shovel.

### BACKGROUND OF THE INVENTION

An electric shovel is driven by electric motors to provide various shovel motions. These include propel, swing, crowd and hoist motions each of which cause the drive motors to draw varying amounts of power during mining operations. A DC bus is used to provide DC power to an inverter associated with each drive motor. The inverter then provides AC power for use by the drive motor.

It is important that the voltage for the DC bus remain relatively constant during the shovel motions. In older generation shovels, a control system is used which provides logic control and includes a rectifier for providing a regulated DC voltage for the DC bus. However, communication with the control system is not straightforward and requires that dedicated ActiveX® controls be written in order to display the internal status of the control system. Further, communication can only take place in accordance with a serial protocol, which is relatively slow. The control system is also expensive to repair or replace and replacement parts are difficult to find. Therefore, there is a need for an updated control system which can be retrofitted into existing mining excavators that provides a rectifier for regulating DC voltage for a DC bus, logic control, substantially improves communications and which does not require special programming.

### SUMMARY OF THE INVENTION

A control system is described for regulating a bus voltage used to power an electric shovel. The system includes a controller for controlling motions of the shovel and for providing a measurement of bus voltage of a bus. The system also includes a shunt resistor located in a current path of the bus and a current transducer for providing a current measurement based on current flowing through the shunt resistor. A converter is then used to regulate the bus voltage of the bus in response to the current and voltage measurements.

### BRIEF DESCRIPTION OF THE DRAWINGS

The figures provide the details of the system of this invention in the construction and the functions. It is a better way to understand the invention in the visualization. Then the following descriptions will explain the invention according to these figures.

FIG. 1 depicts a control system for an electric shovel in accordance with the present invention.

FIG. 2 depicts a circuit configuration for measuring voltage across a DC bus used in a shovel control system.

FIG. 3 depicts test results for a shovel crowd motion full reversal motion test.

### DESCRIPTION OF THE INVENTION

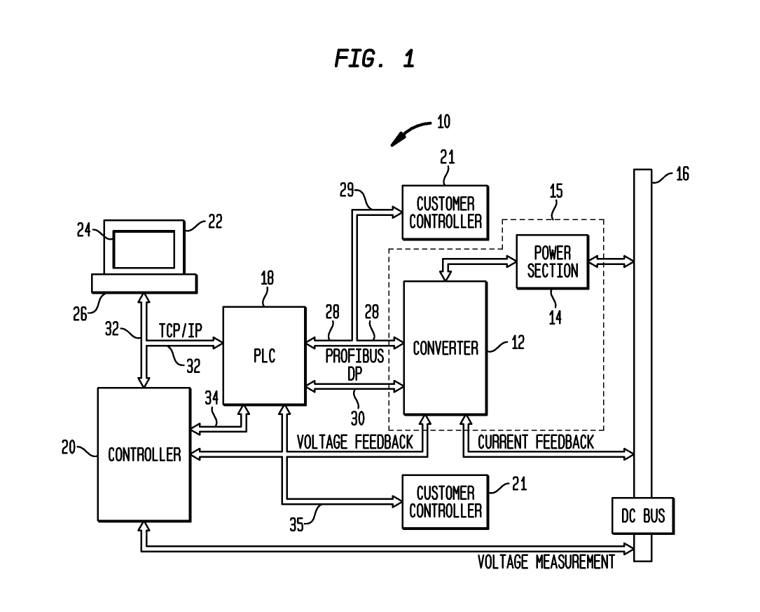

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings. In the description below, like reference numerals and labels are used to describe the same, similar or corresponding parts in the several views of FIGS. 1-3.

The present invention is designed to be retrofit into older generation shovel drive and control systems. Referring to FIG. 1, a control system 10 for an electric shovel is shown. The system 10 includes an AC to DC voltage converter which controls a power section 14. The power section 14 includes pairs of thyristors, which form rectifying bridges and a regenerating bridge to provide DC output voltages. The DC output voltages of the bridges are modified by controlling the duration of conductance for each thyristor. This is achieved by controlling the firing angle, i.e. the point when the thyristor is triggered to conduct. Firing signals for the thyristors are transmitted by pulsing cables. In use, the DC voltage is regulated by changing firing angle as required. The converter 12 and the power section 14 together serve as a rectifier 15 and provide closed loop control for regulating a DC bus voltage on a DC bus 16 that is supplied to the inverters associated with each drive motor. By way of example, the converter 12 may be a Siemens Simoreg® Control Module and the power section 14 may be a Sitor™ thyristor module.

The system 10 also includes a programmable logic controller (i.e. a “PLC”) 18 which interfaces with an existing high speed controller 20 and an existing PLC (not shown) of the system. The PLC 18 controls a human machine interface/maintenance (i.e. HMI) station 22 having a display 24, an operator panel 26, and control panels which enable a user to control the system 10. The HMI station 22 provides visualization of mining process information regarding the shovel and enables an operator/engineer to input control signals to the shovel. The PLC 18 is programmed to provide machine protection functions for the shovel system such as line voltage monitoring, interlocks and drive/process fault handling. The PLC 18 is also programmed to interface with the operator through the HMI, the operator panel and control panels, as well as on/off control of shovel propel, swing, crowd and hoist motions. The PLC 18 may be a Siemens SIMATIC S7-400® process controller. The controller 20 controls all the shovel propel, swing, crowd and hoist motions, protects the power section 14 from damage which may occur from various conditions such as a drive motor over current condition and controls drive harmonics such as the adjustment of the power factor. In one embodiment, the controller 20 may be SIBAS® controller manufactured by Siemens.

Converter status, process data, control and other signals are exchanged between the converter 12 and the PLC 18 via a process field bus connection such as a Profibus® system 28. The Profibus® system 28 enables communication speeds of up to 12 Mbps, which is a significant improvement from conventional systems which use serial communication. In addition, many functions for Profibus communication are built in and special computer programming is not needed.

Critical signals such as pulse enable, external fault and other signals are communicated between the converter 12 and the PLC 18 over a hardwired connection 30. In addition, the PLC 18 is connected to the controller 20 and the HMI maintenance station 22 through an Ethernet 32 to exchange information for the HMI station 22. The PLC 18 is also connected to the controller 20 via a hardwired connection 34 to communicate critical signals such as those for process protection and control. Further, signals may also be provided to a customer controller 21 via Ethernet or a Profibus connection 29 and a hardwired connection 35 for protection, control and visualization. In particular, hardwired connections 30, 34, 35 are used for communicating critical signals in order to avoid network disruptions which may occur with other types of connections.

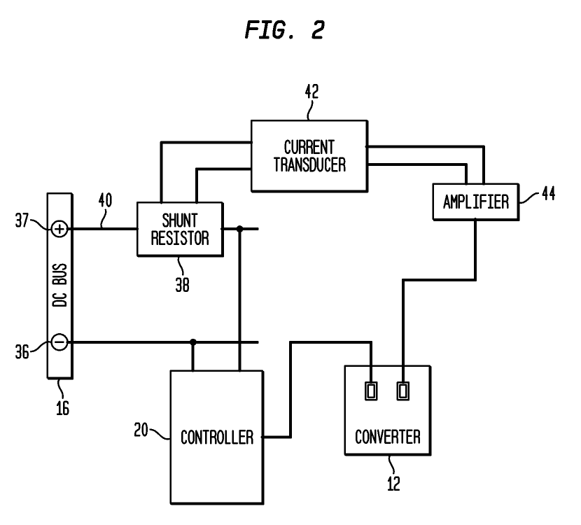

Referring to FIG. 2, a circuit configuration for measuring voltage across the DC bus 16 is shown. The controller 20 includes a voltage measurement capability and is connected in parallel to positive 37 and negative 36 terminals of the DC bus 16 in order to measure bus voltage. The controller 20 is connected to the converter 12 and outputs a voltage measurement signal to the converter 12 as voltage feedback.

A shunt resistor 38 is placed in a current path 40 from the positive terminal 37. A current transducer 42 is connected in parallel across the shunt resistor 38 to measure a DC bus current. A current measurement is made which is then amplified by an amplifier 44 connected between the current transducer 42 and the converter 12. The signal is then provided to the converter 12. The converter 12 includes a cascaded control structure which includes an outer loop for controlling voltage and an inner loop for controlling current. When a shovel motion occurs, current is drawn from the DC bus 16 to provide motor torque. The inner and outer loops serve to provide sufficient current for all shovel motions while simultaneously maintaining a constant bus voltage. The converter 12 regulates the voltage on the bus in response to the current measurement and the voltage measurement. By way of example, the shunt resistor may have a rating of 2500 Amps/100 mV output and the current transducer may have a rating of 150 mV input=10V output.

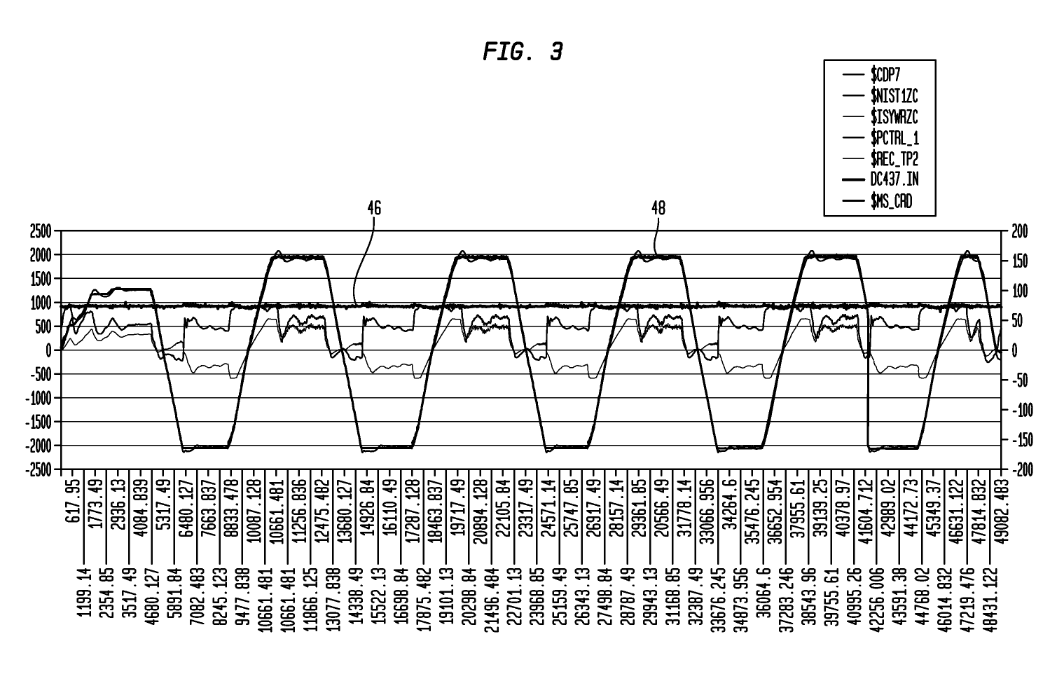

FIG. 3 is a graph depicting test results for the present invention for a crowd motion full reversal motion test. Crowd motion refers to the positioning of a dipper with respect a boom of a mining excavator. In FIG. 3, first graph line 46 represents the DC bus voltage and second graph line 48 represents a speed reference which represents a position of a joystick used for operating the shovel in relation to the entire range of motion for the joystick expressed as a percentage. In accordance with the present invention, it can be seen that the converter 12 maintains the DC bus voltage at a substantially constant voltage level throughout operation of the shovel wherein the speed changes between full forward (i.e. maximum positive speed) and full reverse (i.e. maximum negative speed). In FIG. 3, the DC bus voltage was maintained at a preset value of approximately 910 Volts.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations.

What is claimed is:

1. A control system for regulating a bus voltage of a bus, wherein said bus voltage is used to power an electric shovel:
a controller for controlling motions of said shovel, wherein said controller is adapted for providing a voltage measurement of said bus;
a shunt resistor located in a current path of said bus;
a current transducer for providing a current measurement based on current flowing through said shunt resistor; and
a converter for regulating said bus voltage of said bus in response to said current measurement and said voltage measurement.

2. The system according to claim 1, wherein said converter includes a cascaded control structure for regulating said bus voltage.

3. The system according to claim 2, wherein said cascaded control structure includes an outer loop for controlling voltage and an inner loop for controlling current.

4. The system according to claim 1, further including an amplifier for amplifying a current measurement signal.

5. The system according to claim 1, wherein said voltage is a DC voltage.

6. The system according to claim 1, wherein said shunt resistor has a rating of 2500 Amps and 100 mV output.

7. The system according to claim 1, wherein said current transducer has a rating of 150 mV input to 10V output.

8. The system according to claim 1, wherein said converter includes a power section having thyristors for forming rectifying bridges and a regenerating bridge.

9. A system for controlling motions of an electric shovel, comprising:
a first controller for controlling motions of said shovel, wherein said controller is adapted for providing a voltage measurement of a bus voltage of a bus wherein said bus voltage is used to power said shovel;
a shunt resistor located in a current path of said bus;
a current transducer for providing a current measurement based on current flowing through said shunt resistor;
a converter for regulating said bus voltage of said bus in response to said current measurement and said voltage measurement;
a programmable controller or providing logic control unctions for the shovel; and
a user interface which interfaces with said programmable controller for enabling input control signals to said system and for displaying system information.

10. The system according to claim 9, wherein said converter, programmable controller, first controller and user interface are connected by a network connection.

11. The system according to claim 9, wherein said converter, programmable controller and said first controller are connected by a hardwired connection.

12. The system according to claim 9, wherein said converter includes a cascaded control structure for regulating said bus voltage.

13. The system according to claim 12, wherein said cascaded control structure includes an outer loop for controlling voltage and an inner loop for controlling current.

14. The system according to claim 9, further including an amplifier for amplifying a current measurement signal.

15. The system according to claim 9, wherein said voltage is a DC voltage.

16. The system according to claim 9, wherein said shunt resistor has a rating of 2500 Amps and 100 mV output.

17. The system according to claim 9, wherein said current transducer has a rating of 150 mV input to 10V output.

18. The system according to claim 9, wherein said converter includes a power section having thyristors for forming rectifying bridges and a regenerating bridge.

19. The system according to claim 9, wherein said bus voltage is regulated to maintain approximately 910V.

20. A method for regulating a bus voltage of a bus, wherein said bus voltage is used to power an electric shovel, comprising the steps of:
measuring said bus voltage to provide a voltage measurement;
measuring a current flowing through said bus to provide a current measurement; and
providing a converter having a cascaded control structure for regulating a bus voltage on said bus in response to said current measurement and said voltage measurement.
